(19) United States
(12) Patent Application Publication
(10) Pub. No.: US 2008/0275968 A1
(43) Pub. Date: Nov. 6, 2008

(54) Managing a master method and a child method defined by differing sets of required configurations

(76) Inventor: Roland Springholz, Waldbronn (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/800,465

(22) Filed: May 4, 2007

(51) Int. Cl. G06F 15/177

(52) U.S. Cl. 709/220

(57) ABSTRACT

According to an exemplary embodiment of the invention, a device is provided for managing a master method, defined by a first set of required configurations, and a child method, derived from the master method and being defined by a second set of required configurations, wherein each of the master method and the child method comprises a sequence of instructions for an instrument for at least one of analysing, testing, and measuring a substance, wherein each of the required configurations of the master method and of the child method comprises a set of operating conditions being required for an execution of the master method and of the child method, respectively, using the instrument, the device comprising a determining unit adapted for determining if the second set of required configurations differs from the first set of required configurations, and a classification unit adapted for classifying the child method based on a result of the determination.

### BACKGROUND

The present invention relates to system for managing a master method and a child method derived from the master method.

Measurement systems such as an apparatus of the LC 1090 or 1100 or 1200 series or GC 5890, 6980, or 7890, ACD 35900 modules or MSD devices of Agilent Technologies as well as devices from other industry vendors require a detailed specification according to which a specific measurement or analysis may be carried out. A corresponding sequence of instructions may be defined by a master method which may require, in specific jurisdictions, an official validation before commercial use, such as an FDA (Food and Drug Administration) validation in the United States of America. When a new child method is derived from a master method by modifying the latter, requirements regarding an official validation should be taken into account.

U.S. Pat. No. 5,892,458 discloses an apparatus for the recognition of exchangeable parts in an analytical measuring instrument or in an analytical measurement system with several analytical devices, which contain exchangeable parts. Such an apparatus has identification modules each attached to an exchangeable part, and transmit-receive devices which can receive information signals from an identification module and send information signals to an identification module, and a control device which evaluates the information from an identification module. The control device can cause a message to be displayed on a display device, if the information read out from an identification module does not fulfill certain conditions, for example with regard to the quality of the corresponding part.

However, the situation may occur that, when deriving a child method from a master method, significant changes of one or more parameters or operation conditions in the method may become necessary.

### DISCLOSURE OF THE INVENTION

There may be a need to provide a reliable system for managing a master method and a child method derived from the master method. Correspondingly, the subject-matter of the independent claims is provided. Further embodiments are shown by the dependent claims.

According to an exemplary embodiment of the invention, a device is provided for managing a master method, defined by a first set of required configurations, and a child method, derived from the master method and being defined by a second set of required configurations, wherein each of the master method and the child method comprises a sequence of instructions for an instrument for at least one the group consisting of analyzing, testing, and measuring a substance, wherein the first set of required configurations comprises of a set of operating conditions being required for an execution of the master method using the instrument, wherein the second set of required configurations comprises a set of operating conditions being required for an execution of the child method using the instrument, the device comprising a determining unit adapted for determining whether the second set of required configurations differs from (or is alternatively identical to) the first set of required configurations, and a classification unit adapted for classifying (or categorizing) the child method (more particularly for classifying an access mode to the child method on a user-specific basis) based on a result of the determination.

According to another exemplary embodiment of the invention, it is provided a method of managing a master method, defined by a first set of required configurations, and a child method, derived from the master method and defined by a second set of required configurations, wherein each of the master method and the child method comprises a sequence of instructions for an instrument for at least one of the group consisting of analysing, testing, and measuring a substance, wherein the first set of required configurations comprises of a set of operating conditions being required for an execution of the master method using the instrument, wherein the second set of required configurations comprises a set of operating conditions being required for an execution of the child method using the instrument, the method comprising determining if the second set of required configurations differs from the first set of required configurations, and classifying the child method based on a result of the determination.

According to yet another exemplary embodiment, a computer-readable medium (for example a CD, a DVD, a USB stick, a floppy disk or a harddisk) is provided, in which a computer program of managing a master method and a child method is stored, which computer program, when being executed by a processor (such as a microprocessor or a CPU), is adapted to control or carry out the above-mentioned method.

According to a further exemplary embodiment, a program element (such as a software component in source code or in executable code) of managing a master method and a child method is provided, which program element, when being executed by a processor, is adapted to control or carry out the above-mentioned method.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied to master/child method management architecture. The method classification according to an embodiment of the invention can be realized by a computer program, i.e. by software, or by using one or more special electronic optimization circuits, i.e. in hardware, or in hybrid form, i.e. using software components and hardware components.

In the context of this application, the term “managing” may particularly denote a manual or automatic scheme for handling or treating master methods and child methods in a distributed system (such as a company, a research center, a lab or a network) which distributed system involves multiple human users having different skills. The management may relate to issues such as a modification of master and child methods, conditions or rules for providing access of such methods to authorized or sufficiently skilled persons, and allowing the unlimited or limited use of such methods by specific users.

The term “master method” may particularly denote a method which has already been used beforehand or which has already been certified, for instance in accordance with an FDA validation. Such a master method may define a sequence of procedures involved with an analysis of a (fluidic) sample, for instance in the field of life science. For example, separation of a multi-component fluid may involve a plurality of procedural measures which may be formulated as an algorithm, a set of instructions or a recipe. A master method may have a degree of reliability, experience or validation which degree is higher than a degree of reliability, experience or validation of a child method newly developed on the basis of the master method.

The term “child method” may denote a method being similar (but not necessarily identical) to a master method which goes back to the master method but may be modified to a specific extent. Such a modification may include the deletion of portions, the addition of portions or the alteration of portions of the master method so that a validation or certification of the master method does not necessarily have to cover also the child method.

The term “required configurations” may particularly include a portion of the information included in a master method which portion includes essential core instructions for a procedure corresponding to the master method or child method, respectively. For example, a measurement system may include an instrument which is parameterized by parameters such as fluid flow properties, a gradient applied to a liquid chromatography column, temperature cycles, or wavelengths of electromagnetic radiation involved in a detection procedure during the measurement. Furthermore, parameters indicative of data evaluation such as a quantification of raw data may be part of the required configuration. Such a data evaluation may be configured in such a manner that measurement data are taken as a basis for calculating a result of the measurement. Furthermore, information indicative of a sequence, that is to say an order, of different procedural methods may be included in required configurations. In other words, the required configurations may define basics of an operation of the instrument block. Regarding the master method, the required configuration may be a requirement for operating the master method to meet a validation or a certification.

The term “classification” may particularly denote the fact that the system according to an exemplary embodiment takes a decision how to treat a child method, for instance how reliable and/or accessible the child method shall be. In accordance with such a classification, different categories may be defined for specifying characteristics of the child method, such as a permission for different persons to get access to the child method. Criteria for such a decision may be a degree of deviation between child method and master method, particularly discrepancies between the required configurations of the master and of the child method.

According to an exemplary embodiment, a system is provided which compares the master method with a child method (derived from the master method) regarding deviations in the corresponding required configurations. In case of a deviation, the child method may be classified correspondingly, for instance in a manner to indicate that a certification of the master method can not be transferred automatically or without review or recertification to the child method. In case of no deviation, the child method may be classified correspondingly, for instance in a manner to indicate that a certification of the master method can be transferred automatically or without review or recertification to the child method. Such a system, in a simple and efficient manner, may ensure even in a complex environment in which multiple master methods, child methods and users are present, that no child method is erroneously used without a previous certification, when the deviation between child method and master method is of such an extent that the required configurations are altered. In the context of drug development or drug manufacture, such a system may significantly increase patient security.

For instance, such a master method evaluation system may find application in the context of an “Agilent Cerity Network Data System For Pharmaceutical QA/QC” applications, see the corresponding concept guide, edition 11/2005, manual part No. G4000-90025.

Particularly, a child method derived from a master method which has identical required configurations, may be released without the necessity to take specific measures. However, when the master method is an already defined method (for instance approved) and includes all parameters necessary to carry out a method, then a child method which differs regarding required configuration may have to be analyzed in more detail and cannot be released as such. In other words, a master method may include an algorithm which just has to be fed with specific parameter values in order to carry out the master method. The master method can be implemented in software, but can also be conventionally wired.

A master method and a child method may relate to analytical measurement and evaluation methods, for instance a sequence for carrying out a chromatography experiment. For example, it may be desired to analyse a medication mix of a plurality of substances. In such a scenario, the FDA may require a reproducible process for validation (for instance a formulation, adverse reactions, effects, verification tests, etc.). Other certified methods may include the analysis of a fluidic sample in accordance with a specified method. For instance, this may involve the decision which sample volumes in which solvent shall be used for a chromatography experiment. In a separation procedure, sample and solvent may form a mobile phase and may be separated using a stationary phase such as beads. Different elution forces may then be used for trapping the mobile phase in the stationary phase, and for subsequently removing the mobile phase from the stationary phase (for instance by varying a H₂O/ACN concentration ratio).

According to an exemplary embodiment, an efficient handling of different versions of master methods (or child methods) may be provided. According to one aspect, a (for instance FDA-validated) master method shall be mapped on a child method, which may require a specific classification of the child method (for instance as released or unreleased, depending on whether the modifications between child method and master method are severe or only slight). According to another aspect, an alteration of a (master) method may be performed in the context of a role model. For example, when a master version is updated (for instance a peak may be measured after 20 minutes instead of measuring the peak after 30 minutes), conditions of handling the new version of the master method may be defined. According to the first aspect, an FDA-certified master method shall be mapped to a similar but not identical environment. This may require changing the so-called required configurations, that is to say the necessary properties of the environment. When a deviation from such a required configuration is necessary, such a method may be released as a child method, but may only be made available to persons which have a specific (technical) qualification, for instance a specific technical degree. Therefore, the role of a user may be implemented as a criterion for an authorization or non-authorization of such a user to use the child method. This may ensure that a certification for a master method which requires a certain reproducibility of a procedure is only transferred to a child method when required configurations are not altered. Otherwise, a specific classification of the child method is necessary.

A master method may be a theoretical/abstract instruction, that is to say may be based on the assumption that it is executed on an “ideal” instrument. In contrast to this, a child method may be a personalized master method which relates to a “real” lab instrument. Thus, a child method may be a 1:1 copy of a master method but may be concretized for compliance with a specific instrument. For example, a degasser for degassing a solvent may have ideal functions in an ideal environment, but needs to be specified when run in a specific instrument environment.

For example, two components A, B to be mixed may be provided with relative concentrations of 75% and 20%. Furthermore, a buffer solution C with a concentration of 5% may be added. When a pump shall mix such components, and the master method does not have any buffer functionality included, the child method including such a buffer channel may not be applied 1:1. In another example, an evaluation method of a detection spectrum having two peaks may involve the detection of only one peak in a master method, but of both peaks in a child method. Therefore, when the child method is derived from the master method, for instance to further develop the master method, adaptations or a new certification/validation may be necessary.

In contrast to conventional systems in which a child method is only releasable when it has all required configurations of the master method, exemplary embodiments of the invention do not necessarily have to define a new master method when deviations of the required configurations occur, but may yield to a certain classification of the child method to indicate that the child method has varying required configurations. If this has been recognized, the child method may first be labelled as “unreleased”. Such a label may result in a reduced level of reliability/applicability/officiality. After subsequent certification or validation, the child method may be reclassified into a higher level.

In case that, according to an exemplary embodiment, a child method has been classified as “unreleased”, such a method may presently not be used by each user, but may only be used by users having a specific authorization, so that even an “unreleased child method” may be released for a specific environment and with specific limitations. For instance, a laboratory director or a chemist may get the authorization to use also an unreleased child method, whereas a lab technician and co-workers of a lower or no technical degree may not get the authorization to use such a method. In other words, when a specific competence level is exceeded on a user-by-user basis, an unreleased child method may be used nevertheless.

In accordance with the user-specific competence level, an unreleased method may be classified to be rejected, to be accepted, or to be accepted only with modifications.

According to an exemplary embodiment, this may have the technical effect that even different measurement apparatus units (such as a pump, an ADC, an LC column, etc.) are combinable in a flexible manner, without the danger of distributing non-certified methods. Therefore, the competence of the user may be included in an automatic decision system whether a child method can be freely used or not. Such a decision whether or not authorization to a user is given may involve empiric experience, expert knowledge (which may be defined as decision rules), or Fuzzy logic.

In a specific software implementation, a user may select via a GUI (graphical user interface) a certain master method and a target instrument. Then, a software may classify a child method to be released or unreleased (wherein the classification “unreleased” may also include the label “released with modifications”). Also, a rejection of a requested access to the method is possible. The child method may then be labelled with a signature “released” or “unreleased”. Particularly, a flag may be set regarding the classification of the child method. Such a status may also differ for different users, that is to say may be user-specific.

Decision criteria for classifying a specific method for a specific user as “released” or “unreleased” may be a technical knowledge of the user. Such a measure may also increase the freedom of coupling measurement apparatus components from different manufacturers, since certified methods from one can be transferred to the other one.

Exemplary fields of applications of embodiments of the invention are life science, fundamental research (for instance in the field of chemistry, particularly petrochemistry), or in more general any system which requires a certification or a restricted access.

Other fields of application in which “master child life cycle procedures” can be applied is the field of official administration. For instance, master documents of forms or contracts may be provided on a relatively high administration level (for instance on a country basis). In a specific community in the country, such master methods may then be adapted or extended. When a master method in such a configuration is modified significantly, all documents or forms which include a community specific modification may be considered as a child method which is derived from a master method with modifications.

For instance, a user may “log in” into a computer system by providing login data. The computer system may then track, on the basis of the log-in data of the user, whether and to which extent the user is authorized to get access to specific master methods and/or (released or unreleased) child methods. For this purpose, the methods to which the user desires to get access may have a flag which has an indication regarding the classification of the method. A database may be provided in which user identification data is linked with role data such as a technical competence level of the user. After logging in, the log-in data may be processed in combination with user-specific data stored in the database as a basis for determining access rights of the user.

According to an exemplary embodiment, a master method which has been further developed, such as a modified master method may still fall under the old version of the master method. This may result in a conglomerate of master methods and child methods which is relatively difficult to handle. In order to avoid problems with such conglomerates, it shall always be guaranteed that only child methods which are based on an actual or present master method are used in an application. Thus, when a new version of a master method is issued, the authorization for the use of old child methods and/or master methods may be made dependent on the role of the user, for instance may be dependent on a technical degree of the user. Thus, in a user-specific manner, it can be ensured that users having a high technical level may have access to all or more child methods than a user having a lower technical skill. This allows both flexibility and failure security.

This may allow for an improved retrieval of error-free master/child methods. Therefore, the system may be less prone to failure. Furthermore, an improved reliability of the employment of analytical methods may be possible, and a faster and more reliable retrieval. Depending on the user-specific qualification, the freedom to use or to have access to methods may be defined.

On a time axis, a method may first be classified as an unreleased method and may then be converted into the status of a released method (for instance only by a user having a corresponding competence level). In the intermediate time between the classification as unreleased and the reclassification as released, the access criteria may differ from the access criteria after the reclassification as released method. For instance, a technician may only get access to the method after the reclassification as “released”, whereas a chemist or a head of a research department may have access to the child method during both intervals. This may allow both, an increased flexibility and the avoidance of misuse.

Next, further exemplary embodiments of the device will be explained. However, these embodiments also apply to the method, the computer-readable medium and the program element.

The classification unit may be adapted for classifying the child method as an unreleased method if the second set of required configurations differs from the first set of required configurations, wherein an unreleased method may be denoted as a method which is not approved for unrestricted use by any user. By using the agreement between the required configurations of master and child method as the decision criteria, a reliable classification may be made possible. Only if this core of the master method is changed, the child method has to be analyzed in more detail regarding validity. A child method identified as “unreleased” may be released later by an authorized person or entity.

The classification unit may further be adapted for classifying the child method as a released method if the second set of required configurations is identical to the first set of required configurations, wherein a released method is a method which is approved for an unrestricted use or for a restricted use by a user. Thus, when the required configurations remain unaltered, and only optional or minor changes are involved in the derivation of the child method from the master method, the child method may be used.

The classification unit may be adapted for classifying the child method based on at least one predetermined decision criteria selected from the group consisting of an empiric decision criteria (that is involving decision criteria derived from experience), an expert rule (that is involving decision criteria derived from expert knowledge), and a Fuzzy logic based decision criteria (that is involving decision criteria derived by involving artificial intelligence). Also a trained neural network may contribute to the decision. With these criteria, a meaningful decision of a classification of the child method is possible, optionally involving elements of artificial intelligence or a human-like intelligence which however can be provided by an automatic system.

The device may comprise a reclassification unit adapted for reclassifying the child method upon receipt of a reclassification request of a user, wherein reclassifying includes one of changing a status of the child method from unreleased to released, changing a status of the child method from released to unreleased, changing a status of the child method from unreleased to released with restrictions, and changing a status of the child method from released with restrictions to unreleased. Therefore, when the status of the child method has meanwhile changed, it is possible to alter the class or status of the child method in the system, for instance when no reasons remain why the child method shall not be provided even to people with relatively low technical skill, for example after validation of the child method by an authorized person. On the other hand, when a child method which previously has been classified as “released” has meanwhile shown that there are problems with such a classification, then the degree of restriction to the access may be increased.

The reclassification unit may be adapted for allowing or rejecting a reclassification request based on a role of a user, particularly based on a degree of a technical competence of a user or based on a hierarchical position of a user in a social structure. The criteria whether a reclassification is accepted may be made dependent on the skill or position of the user. For instance, when the user has a high technical skill such as a head of the research department, a reclassification may be made possible without restrictions. On the other hand, the lower the hierarchical position in a social structure such as a company or a research group, the lower are the administration rights of such a user for carrying out a reclassification.

The device may comprise a flag unit adapted for flagging a reclassified child method with a flag indicative of an identity of the user. Therefore, when the user has changed a classification of a child method, this can always be retraced later based on the history stored with such a flag in conjunction with the reclassified child method.

Each of the master method and the child method may comprise a sequence of instructions for operating a measurement apparatus or a life science apparatus. For instance, a measurement apparatus for performing a measurement in a coupled measurement environment, a measurement device for measuring at least one physical, chemical or biological parameter (the term “physical parameter may particularly denote a size or a temperature of the fluid; the term “chemical parameter” may particularly denote a concentration of a fraction of the analyte, an affinity parameter, or the like; the term “biological parameter” may particularly be a concentration of a protein, a gene or the like in a biochemical solution, a biological activity of a component, etc.), a measurement device for performing a measurement of a fluidic sample, a sensor device, a device for chemical, biological and/or pharmaceutical analysis, a fluid separation system adapted for separating components of a fluid, a test device for testing a device under test or a substance, a capillary electrophoresis device, a liquid chromatography device, a gas chromatography device, an electronic measurement device or a mass spectroscopy device may be the system by which the analysis is performed. Particularly, in such technical scenarios, the sequence of instructions for operating such a system may be formulated in the context of a master method or a child method derived therefrom. Such a child method may relate to a modified instruction scheme. An example for a measurement system which may involve method management schemes according to an exemplary embodiment is an apparatus of the 1100 or 1200 series LC/MSD of Agilent Technologies. Any apparatus having modular or exchangeable parts in an analytical measuring instrument or in an analytical measurement system with several analytical devices may implement embodiments of the method management scheme.

The master method may be a certified method, particularly an officially certified method, more particularly a Food and Drug Administration certified method. Such a certification may be necessary in specific jurisdictions, such as the United States of America, to allow the commercial distribution of such a system. Therefore, by considering such official certification requirements when deriving child methods from master methods, compliance with such certifications may be ensured reliably. Also the child method may be an uncertified method, particularly a method not being officially certified, more particularly a method which is not certified by the Food and Drug Administration. In such a scenario, reclassification of the method from released to unreleased, or vice versa, may be an efficient tool to maintain the compliance with the official certification requirements or validation requirements.

The child version may be an updated version of the master method, wherein an updated version may be a successor version replacing a previous version which has been used earlier in time. With such an update, a modification also of the required configurations may be necessary, which may make it necessary to classify the child method as unreleased.

The device may comprise an authorization unit adapted for allocating a child method access mode to a user which child method access mode is representative for an access authorization for the user to the child method. Therefore, in dependence of the person desiring access to a method, different degrees of access may be given. Thus, misuse and unauthorized use of a child method may be prevented.

The access authorization unit may include one of an unlimited permission (that is to say a permission without any restrictions), a limited permission (that is to say a permission to use the method with specific requirements) and a prohibition for the user to use the child method (that is to say an absolute denying of the access).

The authorization unit may be adapted for allocating the child method access mode to the user based on a role of the user, particularly based on a degree of a technical competence of a user or based on a hierarchical position of a user in a social structure. The criteria whether a reclassification is accepted may be made dependent on the skill or position of the user. For instance, when the user has a high technical skill such as a head of the research department, a child method access may be made possible without restrictions. On the other hand, the lower the hierarchical position in a social structure such as a company or a research group, the lower are the access rights of such a user for accessing a child method, particularly for accessing an unreleased child method.

The authorization may particularly be adapted for allocating a child method access mode of the group consisting of an unrestricted access to the child method, a restricted access to the child method, and a refused access to the child method. An “unrestricted” access may denote that the user can have read and write authorization to the child method. However, when this shall be restricted (for instance only a read mode), a restricted access may be awarded. If the technical skill of a person is very low, the access to the child method may be refused at all, to avoid errors and misuse.

The authorization unit may be adapted for allocating a master method access mode to the user which master method access mode is representative for an access authorization of the user to the master method. Again, also the access to the master method may be regulated in a similar manner as the access to the child methods (see description above).

The first set of required configurations and the second set of required configurations may be indicative of at least one operating condition of the group consisting of a measurement routine parameter, a manufacture procedure parameter, a life science experiment parameter, a sample analysis procedure parameter, and a measurement device operation parameter. The measurement routine parameter may be a parameter which is required within the context of the execution of a measurement routine, for instance a temperature value, a concentration, an amount of a substance, etc. A manufacture procedure parameter may include information about a manufacturing procedure or about components for the manufacture of a substance, for instance of a medication. A life science experiment parameter may, for instance, be a parameter for a liquid chromatography column, such as materials used for a mobile phase and a stationary phase, time parameters, gradient parameters, etc. The sample analysis procedure may be any procedure which is related to the analysis of a sample, for instance the provision of one or two trapping columns and the chemical conditions there. The measurement device operation parameters may include a sequence of procedural steps included in measurement such as a biochemical measurement. It may also include the combination of different measurement components.

The child method may be derived from the master method by at least one of updating, correcting, improving, extending, limiting, concretizing, modifying and application-specifically adapting the sequence of instructions. Updating may denote the transfer of an older version to a new version, by altering one or more parameters. Correcting or improving may include removing errors or deficiencies from a previous version of the method. Extending the master method may include the inclusion or addition of additional instructions. The limitation of a master method may include the deletion of individual instructions. The concretizing may include the specification of general instructions to a specific application. The modification may denote the substitution of instructions by other instructions.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a system for managing master methods and child methods according to an exemplary embodiment of the invention.

FIG. 2 schematically illustrates logical processes of deriving child methods from a master method.

FIG. 3 schematically illustrates logical processes of deriving child methods from a master method and of updating a master method.

FIG. 4 and FIG. 5 illustrate a master method life cycle relationship to instrument method usage for new sequences.

FIG. 6 is a screenshot showing a method context menu of a user interface specification.

FIG. 7 is a screenshot showing a user interface specification for management console role capabilities.

FIG. 8A is a screenshot showing a user interface specification for a sequence dialog.

FIG. 8B is a screenshot showing management console role capabilities for restricted editing on master methods.

FIG. 8C is a screenshot showing management console role capabilities for fine tailored method lifecycle management.

FIG. 9 is a screenshot of a user interface specification for a sample screen.

FIG. 10 is a screenshot of a user interface specification of a sample table method drop down combo box.

FIG. 11 is a screenshot of a user interface specification of a query wizard for method context showing attributes to concerning method lifecycle states.

FIG. 12 is a screenshot of a user interface specification of a query wizard for method context showing.

FIG. 13 is a screenshot of a user interface specification of a method view.

FIG. 14 is a screenshot of a user interface specification of a management console screen.

FIG. 15 is a screenshot of a user interface specification of a method wizard instrument page screen.

FIG. 16 is a screenshot of a user interface specification of a method wizard summary page screen.

FIG. 17 is a screenshot of a user interface specification of a method log book entry.

The illustration in the drawing is schematically.

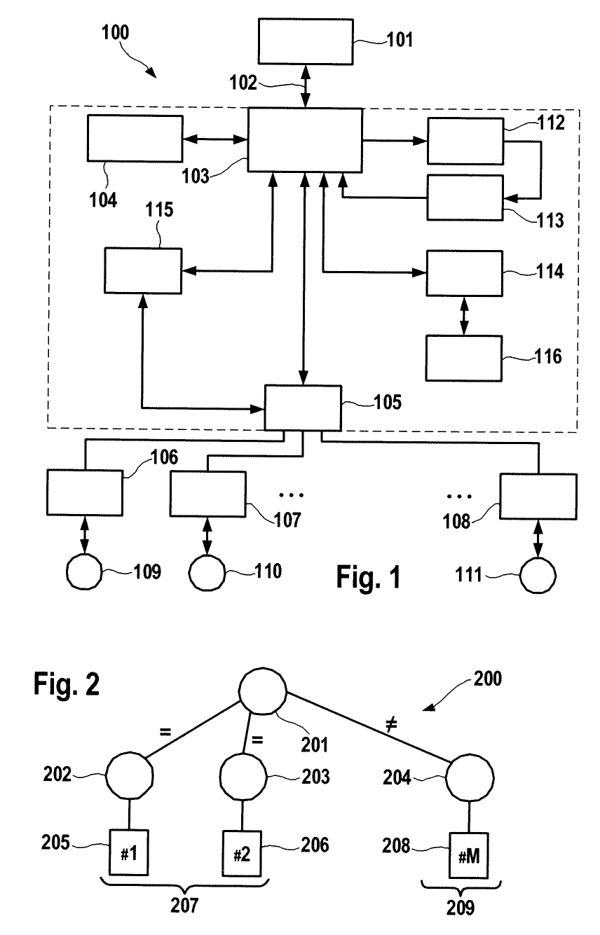

In the following, referring to FIG. 1, an apparatus 100 for managing a master method and a child method for operating a life science apparatus (such as a measurement tower comprising multiple measurement units for a biochemical separation experiment for separating multiple components of a fluidic sample) according to an exemplary embodiment of the invention will be explained.

The master method is defined by a first set of required configurations (defining the biochemical separation experiment), and the child method is developed based on the master method and is defined by a second set of required configurations (defining a modified biochemical separation experiment). Each of the master method and the child method may comprise a sequence of instructions for the measurement apparatus for analyzing, testing or measuring a substance. Each of the required configurations of the master method and the child method may comprise a set of operating conditions being required for an execution of the master method and the child method, respectively, using the measurement apparatus.

In the following, the components of the device 100 will be explained in more detail.

An input/output unit 101 is provided via which data 102 indicative of a master method or a child method can be input to the system (for instance by a method manager). The master method and the child method are both a sequence of instructions needed for running the measurement apparatus (not shown).

Therefore, the data 102 may be supplied to a central processing unit (CPU) 103 of the device 100. The central processing unit 103 may be a control unit and may be substituted by a microcontroller or the like. A memory unit 104 such as an EEPROM is communicatively coupled to the CPU 103 so that the CPU 103 can store data in the memory unit 104 and may retrieve data stored in the memory unit 104. Furthermore, the CPU 103 is coupled to a communication interface unit 104 which provides a communication interface to a plurality of user terminals 106 to 108. Via each user terminal 106 to 108, a corresponding user 109 to 111 may access the apparatus 100. It is also possible that data indicative of a master method or a child method is input to the system 100 via one of the terminals 106 to 108.

Each of the users 109 to 111 may be employees of a company running the system 100. For example, the first user 109 may be a head of a research development department, the second user 110 may be a chemist, and the third user 111 may be lab technician. Therefore, the technical skill of the first user 109 may be higher than the technical skill of the second user 110, and the technical skill of the second user 110 may be higher than the technical skill of the third user 111. Via the assigned user terminals 106 to 108, each of the users 109 to 111 can, after logging in with specific log-in information (such as an identification and a password), access the apparatus 100 via the bidirectional communication interface 105. The communication between the terminals 106 to 108 and the communication interface 105 may be wired or wireless.

The user interfaces 101, 106 to 108 may comprise a display device like a cathode ray tube, an LCD device or plasma device. Furthermore, one or more input elements may be provided like a keypad, a joystick, a trackball or even a microphone of a voice recognition system.

For instance, anyone of the users 109 to 111 can try to get access, via the assigned user terminal 106 to 108 and the communication interface 105, to data indicative of the master method or the child method stored in the system 100, for instance when the user 109 to 111 wishes to use or modify such a method. However, as will be described in the following, access may be restricted or prohibited when a child method is present in the system 100 which is derived from a master method and which differs from the master method regarding the required configurations.

Namely, when a child method is derived from a master method, a determining unit 112 may determine if a second set of required configurations (assigned to the derived child method) differs from a first set of required configurations (assigned to the master method). In accordance with the result of the determination of the determination unit 112, a classification unit 113 which is communicatively coupled to the determination unit 112 classifies the child method accordingly. For instance, when there is a deviation in the required configurations between master method (measuring module/instrument), and derived child method (measuring module/instrument), it is possible that the corresponding child method is classified to be “unreleased”. This information may be conveyed from the classification unit 113 to the CPU 103 which may store corresponding information in the memory unit 104. On the other hand, when the required configurations of the master method and the derived child method are identical, the child method may be stored in the EEPROM 104 as a “released” method. For the classification, the classification unit 113 may use one or more decision criteria such an empiric decision criterion, an expert rule, or a Fuzzy logic algorithm based decision criteria.

A reclassification unit 114 is provided which can reclassify a child method upon receipt of a reclassification request of one of the users 109 to 111 or of a user operating the input/output unit 101. For instance, when a previously unreleased child method has meanwhile been validated or certified for instance by the FDA or other certified qualified personal, the classification of this child method may then be updated from “unreleased” to “released”. The authorization to perform such a reclassification may depend on a technical competence of a user 109 to 111 inputting such a reclassification. For instance, the head of the research department 109 may have more reclassification rights than the technician 111. Thus, in an EEPROM 104, each user 109 to 111 may have an assigned competence level which can be compared with log-in information provided by the users 109 to 111 when logging in the terminals 106 to 108, so as to ensure that the reclassification of a child method may only be performed by a user having a specific competence or authorization.

Moreover, when a child method is reclassified, a flag may be attached to the reclassified child method so that it can be later retraced unambiguously, which user has performed the reclassification. The flag may be set by a flagging unit 116 which is coupled to the reclassification unit 114.

Furthermore, an authorization unit 115 is provided and adapted for allocating a child method access mode to a user which child method access mode is representative for an access authorization for the user to the child method. Therefore, when one of the users 109 to 111 desires access to a specific child method stored in the memory unit 104, the authorization unit 115 may check whether this specific user has corresponding access rights, and may correspondingly allow for an unlimited permission or a limited permission or may prohibit access of the specific one of the users 109 to 111 to use the child method. Again, the authorization may be made dependent on the role of the users 109 to 111.

Thus, in the system of FIG. 1, information indicative of master methods and (therefrom derived) child methods may be stored. When users 109 to 111 desire access to such child methods or master methods, the access can be granted or denied on the basis of the role of the users 109 to 111 which can depend on the technical and/or hierarchical status of the user in a company. Thus, when one of the users 109 to 111 logs in the system 100 and desires access to specific information or desires to modify child methods or master methods, the authorization is checked by the system 100. Furthermore, within the system 100, child methods which are derived from master methods and differ regarding required configurations may be labelled as “unreleased”, whereas child methods derived from a master method and having the same required configurations and differing only in details, may be flagged as “released” methods.

FIG. 2 illustrates a schematic diagram 200 in which a handling of an unreleased child method will be explained.

A master method 201 may be present and may be already certified, for instance may be FDA-validated. From this master method 201, a first child method 202, a second child method 203, . . . , and an M-th child method 204 may be derived. As indicated schematically in FIG. 2, the first child method 202 may be identical (“=”) to the corresponding master method 201, and the second child method 203 is identical regarding required configurations to the master method 201 (“=”). The first child method 202 may correspond to an operation of a first instrument 205, whereas the second child method 203 may correspond to the operation of a second instrument 206. Due to the identical required configurations of the child methods 202, 203 and the master method 201, the child methods 202 and 203 may be classified as “released”, as indicated by reference numeral 207.

In contrast to this, the M-th child method 204 derived from the master method 201 differs regarding the required configurations from the master method 201. This is indicated schematically in FIG. 2 (“≠”). The M-th child method 204 defines operation of an M-th instrument 207, for instance a unit of an analytical measurement system. Since the instrument configuration between the M-th child method 204 and the corresponding master method 201 are similar but not identical regarding the required configurations, the M-th child method 204 may be classified as an “unreleased” child method, which is indicated schematically with reference numeral 209. Thus, the M-th child method 204 which is classified to be “unreleased” has to be released by an authorized person before it can be used by other persons.

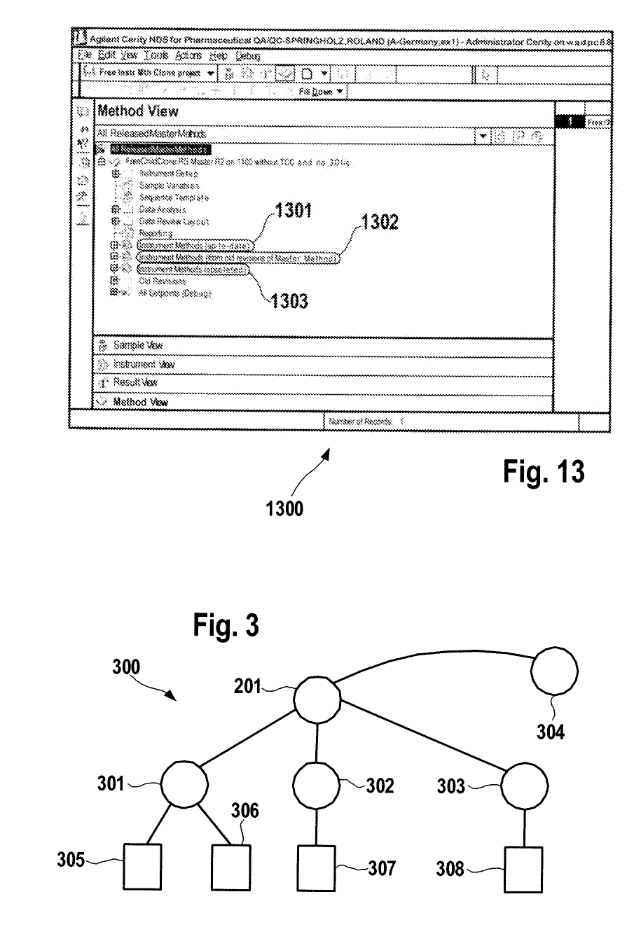

Referring to FIG. 3, a schematic diagram 300 will be explained illustrating a role mode for method developments.

Again, FIG. 3 shows a master method 201. This master method 201 may be modified so that a new version of the master method 201 can be generated, which is indicated with reference numeral 304. However, it is also possible that a first child method 301, a second child method 302 and a third child method 303 are derived from the master method 201. For example, the first child method 301 may be indicative of the operation of a first instrument 305 and of a second instrument 306. The second child method 302 may be indicative of the operation of a third instrument 307. The third child model 303 may be representative for instructions for operating a fourth instrument 308.

As can be taken from FIG. 3, in case of a new version of the master method 201 (see reference numeral 304), access to a new and old version of the master method 201 and of child methods 301 to 303 may depend on the role of a user.

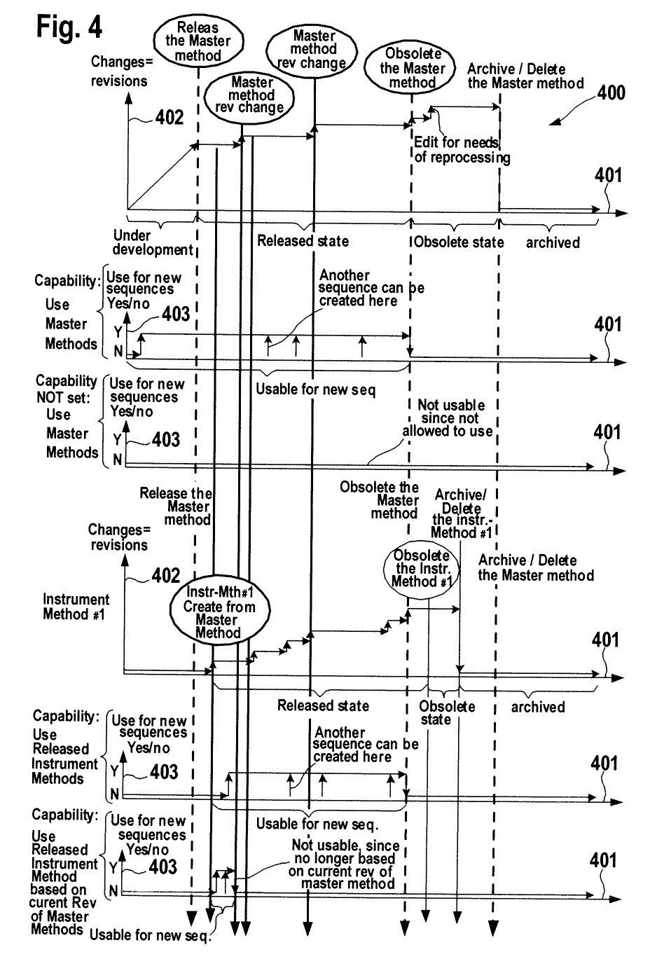

In the following, referring to FIG. 4 to FIG. 17, further exemplary embodiments will be explained.

Next, a component external reference specification Cerity-method lifecycle will be explained which may lead to a secure method usage.

Wider usage of Cerity especially in the constellation of a master method running on instruments doing the analysis work for one special product, it becomes more apparent that the method's usage should be made even more secure. This goes together with a lifecycle that a method goes through, just as most other items used in a production environment follow a lifecycle path, for example SOPs, formulations, production guidelines, safety rules, etc.

A goal in the design is that the usage of the ‘correct’ methods is highly facilitated and incorrect usage is made nearly impossible.

The design targets to improve operation particularly for two extreme groups of users: the simple operator, that should use the 100% correct method for running new samples and sequences, and the method developer that needs to focus on just the set of methods that are the master methods. Of Course many gradations in between are also possible.

The concept may be facilitated by the use of capabilities that are tied to a role which every user caries with him or her. Via the states of a master method that depict its lifecycle, it may be ensured that the user's roles only make use of the intended set of methods for their new samples and sequences. One aspect is that enabling usage of master methods may be tied to a more competent and knowledgeable group of persons. As well as create child methods for dissimilar instruments may need a higher qualification of a person. It is possible that unreleasing or obsoleting instrument child methods can be done by everyone, but reactivating such a method may also require higher competence level. In data review there are no such problems since for reprocessing, the data may always stay with the correct method. A case where a method is selected is in the operation of creating a ‘copy for a different method’. The correct method selection can be defined in the user defined queries that can be configured to suite one's purpose. This query can already be user tailored.

The benefit of such an embodiment can be seen as the last consequence of already existing concepts about releasing of master methods, creating instrument child methods and inheriting or not inheriting such attributes as released state and obsolescence, and (already existing) database attributes. Using these attributes as filters may now generate great improvement in large installations that have to manage many methods. A capability “Edit Master Method” may allow the lab to control the group of persons which have the right to edit the master method and thereby allowing to absolutely exclude other groups of persons from this. This truly is a way to restrict the group of persons who can do master method changes.

In the following, a workflow description of the concept according to an exemplary embodiment will be explained.

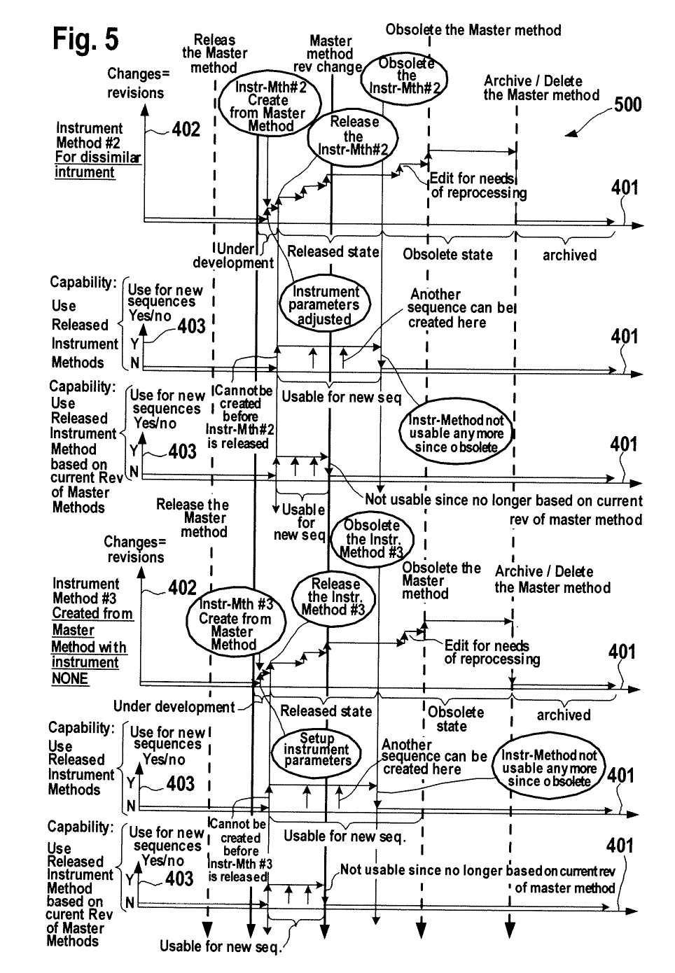

Diagrams 400, 500 in FIG. 4 and FIG. 5 explain the lifecycle of master and instrument methods and their pertinence to the usage for new samples or sequences. It is advantageous to clearly understand what it means that the method cannot be used for new samples or sequences. It may particularly mean that the method cannot be seen in the method selection boxes at the point where the method for a new sample or sequence can be chosen.

FIG. 4 and FIG. 5 illustrate diagrams which schematically show changes in a master method and in different instrument methods. For this purpose, horizontal axes 401 in FIG. 4 and FIG. 5 illustrate the time in arbitrary units, whereas vertical axes 402 in FIG. 4 and FIG. 5 illustrate changes (for instance further development) in the methods in arbitrary units, and vertical axes 403 illustrate “digital” information whether methods may be used or not.

Next, a concept description per component will be given.

First, a method action menu for the method lifecycle states will be explained.

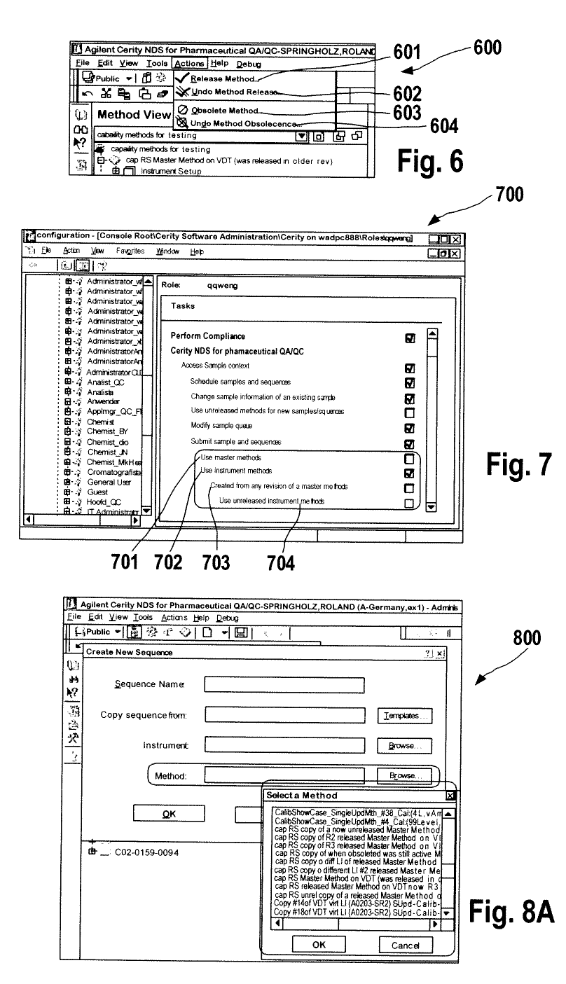

There are dedicated menu items under “Action” in the method context. There is an item group to set the method state from “under development” to “released”. The meaning of this state is that the methods development was successfully completed and that the method is now tested and can be used in the wider lab for operation under quality assurance (QA) production environment. These are the menu items “Release Method” and to revert the state “Undo Method Release” (see items 601 and 602 in a screenshot 600 in FIG. 6).

Items 603, 604 about the method's obsolescence may be used when master methods or instrument methods are phased out of usage. The software may enforce that obsolete methods can no longer be used for running new samples or sequences in the lab. This holds for master methods as well as for instrument methods. Through capability settings it is also possible to restrict the use of instrument methods to only those being based on the current revision of the master method plus that it is not an obsoleted master method. With this concept any change in a master method, which represents a slight change of parameters, cannot by accident be used by operators being subjected to such a strong restriction.

Next, a capability for new samples/sequences will be explained.

Capabilities are provided for a Cerity system to be set in a Microsoft management console for Cerity.

Four capabilities are located under the capability to submit new samples and sequences, because this is where they come into play. The effect of these capabilities is experienced in the method drop down combobox of the sample entry dialog for new samples, and in the method's browse pushbutton found in the new sequence dialog. The four capabilities have the following effects:

“Use master methods” (see item 701 in screenshot 700 in FIG. 7): checked means that in the choice list of methods (for new samples or new sequences) contains master methods. If the user should only be faced with master methods then “Use instrument methods” (see item 702 in screenshot 700 in FIG. 7) must not be checked. Un-checked of item 701 means that in the choice list of methods does not contain any master methods. This may have the intention that a user's role can be exempted from using master methods at all, since they will not show up in the method choice list for new samples nor for new sequences.

The next hierarchical block is all about restrictive usage of instrument-child methods. It is best explained from the least restrictive to the most restricted choice.

The settings for least restrictive instrument method usage is when the user is allowed to use any instrument methods regardless if they are unreleased, or not from the current revision of the master method. This is achieved when all checkmarks are set for: “Use instrument methods” 702, and “Created from any revision of a master method” (see item 703 in screenshot 700 in FIG. 7), and “Use unreleased instrument methods” (see item 704 in screenshot 700 in FIG. 7).

The next level more restrictive usage of instrument methods is that the operator may use only instrument methods which are in the state of having being released. The use case for this is that a method administrator (having capability to “release methods”) can make an instrument method obsolete by intention. Or instrument methods cannot be used as long as they are not yet in the released state, which happens in conjunction with the feature to allow to create instrument methods from master methods for dissimilar instrument configurations, which results in the instrument method's release state will be dropped to unreleased, since the instrument parameters must be checked in detail before the method complies to the master method's intend. Once this procedure was done the instrument method shall then be released to signal that it is OK to be used by the operators in the lab. This is achieved when checkmarks are set for: “Use instrument methods” 702, and “Created from any revision of a master method” 703, but leaving the following capability un-checked: “Use unreleased instrument methods” 704.

The most restrictive usage of instrument methods in the present embodiment is that the operator may use only instrument methods which are derived only from the current revision of the master method plus that the master method is still released and not obsolete yet. This is achieved when a checkmark is set for: “Use instrument methods” 702, but leaving the following capabilities un-checked: “Created from any revision of a master method” 703, and”, Use unreleased instrument methods” 704.

Both method usage allowances for master methods and any restriction for instrument-child methods can set in any combination. The backward compatible setting is that all checkmarks are set for all capability items: “Use master methods” 701, “Use instrument methods” 702, “Created from any revision of a master method” 703, and “Use unreleased instrument methods” 704.

Next, a capability of restricting editing on master methods in a Microsoft management console for Cerity will be explained. New capabilities may be created for the Cerity system to be set in the Microsoft management console for Cerity. This capability may be located under the capability to access method context further down access edit method. It may be called “edit master method”. It may be only a principal capability, which means it does not allow automatically to edit anything in the method, what is exactly allowed to be edited in the method may still be set up via the other method editing capabilities. This capability only ensures when it is not set that this user role does not in any case edit the master method regardless of the settings in the other method editing capabilities. The backward compatible setting is that the checkmark is set for this new capability.

Next, a fine tailored set of capabilities for releasing/obsoleting master and child methods in a Microsoft management console will be explained.

Capabilities may be created for the Cerity system to be set in the Microsoft management console for Cerity. This capability may be located under the capability to access method context. It may be called “Manage Method Lifecycle”. There is one capability to allow setting: release, unrelease or obsolete and undo obsolescence of master methods.

There may be two capabilities for the method lifecycle of instrument child methods: One may be for releasing an instrument method which requires a certain knowledge/skill level. The other is for undoing obsolescence of a child method. A reason keeping unreleasing and obsoleting child methods open for everyone may be that even moderate level lab workers should always be in the position to unrelease an instrument child method when the instrument is no longer correctly functioning. Just on the same lines obsoleting an instrument child method is also open for every one to do since the new mode of operation of creating a new instrument child method, when anything is no longer ok with the existing instrument child method makes the older one automatically obsolete from usage in the method wizard. The backward compatible setting is that all the checkmarks are set in the capability group.

Next, a sequence dialog and samples method selection will be explained.

The common shared code for both features reads out the capabilities that are tied to a user's role and maps the capability to a suffix to be appended to the query body table SQL root name for each of the following three cases:

_CQ_GetMethodByCategoryProject for use when used sequence template to see if this method is at all still valid

_CQ_GetMethodByUserCategoryProject used when first select method in UI (shows all methods modified/owned by this user)

_CQ_GetMethodListByInstrumentProject used when first select instrument in UI (shows all methods for this instrument)

The suffixes are as follows:

“” (empty) when all capabilities are checked

“_NoMethodsAllowed_ONLY’” when none of the capabilities is checked.

“_MasterMth_ONLY” when only the capability “Use master methods” is checked.

“_MMth_IMthReleased_ONLY” when only “Use master methods” and “Use instrument methods” and “Created from any revision of a master method”, capabilities are checked.

“_MMth_IMthOfCurrMaster_ONLY” when only “Use master methods” and “Use instrument methods” capabilities are checked.

“_RelInstrMth_CurrMaster_ONLY” when only “Use instrument methods” capability is checked.

“_RelInstrMth_CurrMaster_ONLY” when only “Use instrument methods capability is checked.

“_RelInstrMth_ONLY” when only “Use instrument methods”, and “Created from any revision of a master method” capabilities are checked.

“_AllInstrMth_ONLY” when only “Use instrument methods”, and “Created from any revision of a master method” and “Use unreleased instrument methods” capabilities are checked.

All these queries can potentially be customized. They are located in a querybodytable and their parameter setup for the SQL queries is located in a filtertable.

Next, an instrument method wizard will be explained.

The following application semantics may be used:

Rule 1: Only a released master method can be used as a template for an instrument-child method.

Rule 2: when the master method is of type instrument NONE, then all instruments can be selected per definition, but the instrument-child method is then changing its state to non-released.

Rule 3: when chosen instrument for the child method is identical in configuration and modules as is the master method then the instrument method stays in the released state, unless dissimilar instruments choice was checked in the method wizard (only with appropriate role this is possible).

Rule 4: obsoleted methods can be taken as templates for an instrument-child method. The instrument method will then also start with the state being obsolete. To avoid even selecting this obsolete master methods, one can refine the user defined queries for AllReleasedMasterMethods for instance to only allow methods which have the Method_active_flag=−1. This is then user specific semantics. Nevertheless the obsolete instrument methods would need to be made non obsolete again in order to be usable for new samples/sequences at all (if so the users role allows this).

Next, a master method treeview will be explained which presents instrument methods according to their validity. This ties in into the application semantics.

Instrument methods may be grouped into three categories, such that the most relevant methods are shown first and are more easy to select from. The top most category is the one where instrument methods are based and created from the current revision of the master method only. So it may be easy to see which of the instrument methods are current and which are not. The second category contains all instrument methods which are created from revisions of the master method that existed before the now current revision. The last category contains only obsoleted instrument methods, these are methods that the operator can deliberately set to obsolete in order to show that they are not to be used any more. This presentation allows to easily determine which instrument methods are out of date when the master method was updated due to an improvement and therefore the current revision is of a higher revision then.

Next, query wizard template names for method queries will be discussed.

The query templates may tie into the application. Semantics for the methods may be filtered out for moderate level operator usage. They may show the methods in a flat view treeview list which leaves out the hierarchical subordinated master child method view of a M_MasterStandardReview query template. The query templates may be M_InstrumentMethodUpToDateReview and M_InstrumentMethodRelStateReview.

Next, action menu items will be explained.

Action menu items “Obsolete” and “Urido Obsolescence” of a method may allow users having the capability to “Release Methods” to perform this operation. The operation may always be secured by the need to accept this change in a message box. The operation “Obsolete” a method additionally appends the suffix to the method name “-Obsoleted (<current date>)” so that this fact is more clearly documented in the treeview display as well as in printout. The concept of the reprocessing may be used to show in the text when this operation was performed. A gain of this concept may be that the operators can create the next up to date new instrument method with the same name as before, thus staying in the definitions of most SOPs.

Next, operational specifications will be given.

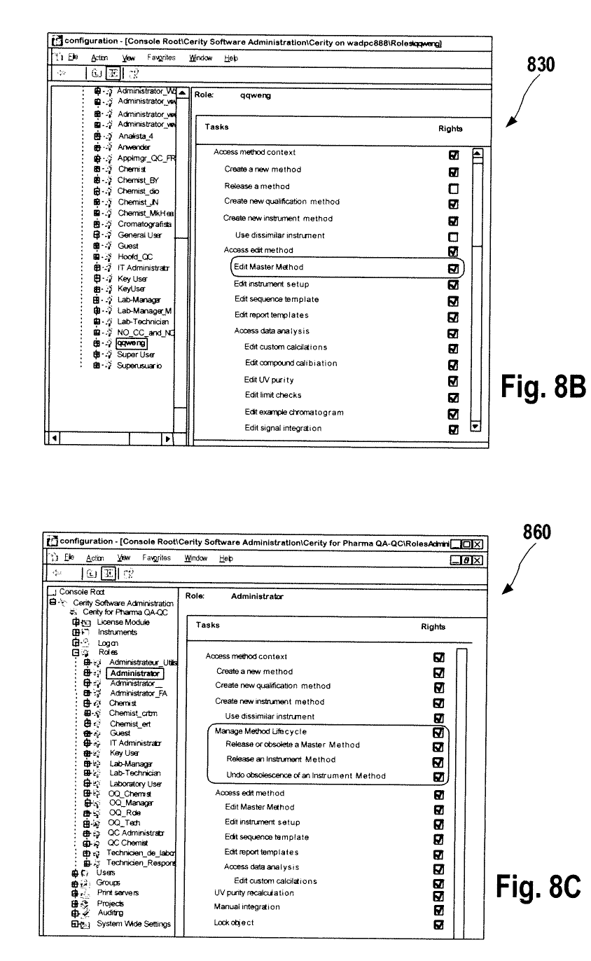

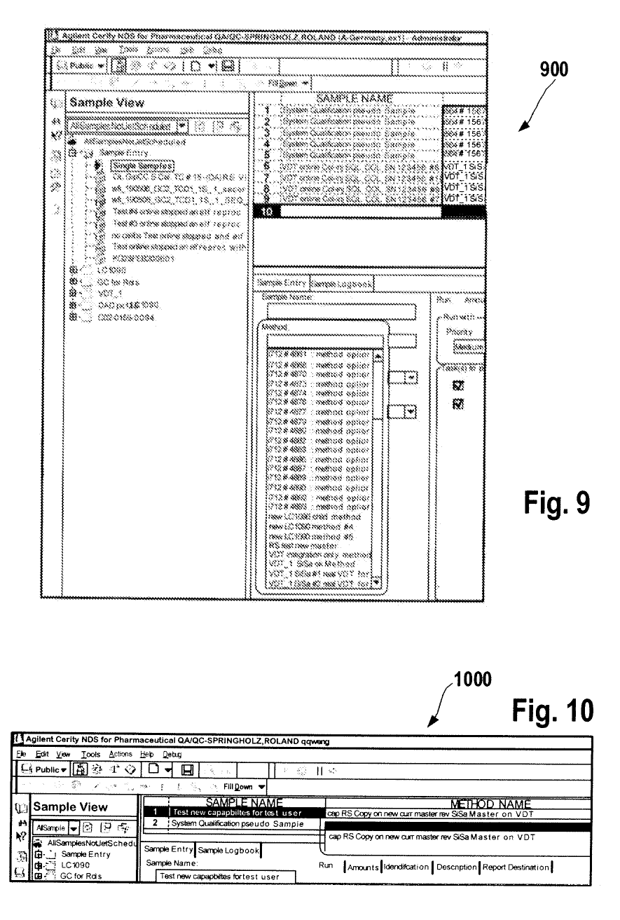

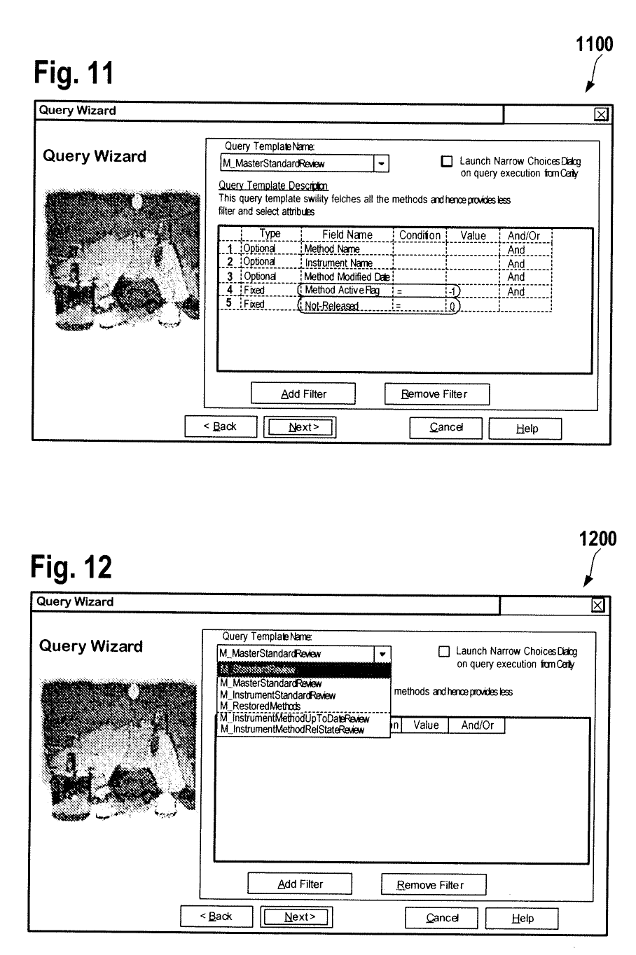

A user interface specification includes the method context menu 600 shown in FIG. 6, the management console role capabilities 700 for new samples/sequences shown in FIG. 7, the new sequence dialog 800 shown in FIG. 8A, the management console role capabilities for restricted editing on master methods 830 shown in FIG. 8B, the management console role capabilities for fine tailored method lifecycle management 860 shown in FIG. 8C, the new sample screen 900 shown in FIG. 9, the sample table method drop down combobox shown in FIG. 10, the query wizard for method context screen 1100 showing attributes concerning the method lifecycle states shown in FIG. 11, and the query wizard 1200 for method context shown in FIG. 12.

Next, the treeview presentation for queries based on the query template name will be explained:

M_MasterStandardReview like the factory query called AllReleasedMasterMethods will now sort the Instrument methods that belong to a specific master methods in three categories: “Instrument Methods (up-to-date)” 1301, “Instrument Methods (from old revisions of Master Method)” 1302, “Instrument Methods (obsoleted)” 1303, see screen 1300 shown in FIG. 13.

The category (up-to-date) means that these instrument methods are based on the current revision of the master method. The term “(from old revisions of Master Method)” means that these instrument methods were created from older revision that the now current revision of the master method. The term “(obsoleted)” means that these instrument methods were made obsolete by an operator.

In the following, a free instrument choice option for a component external reference specification master instrument method will be explained.

A current concept in Cerity for creating an instrument child method from an existing master method has the following background: the master method is supposed to be setup by users being master method developers, who do all the validation work and all the checking of the method's correctness according to a prescribed SOP. Instrument child methods are then supposed to be created by operators. In Cerity operators may be granted to have the limited capability to create instrument/child methods only, which does not allow them to create master methods. This way they can only derive instrument child methods from master methods. Instrument child methods are then supposed to be used in the operator's daily work.

In order to derive an instrument child method, the master method should have been previously released, which is the state exposed that the method is proven to be valid. The instrument child method is then a copy of the master method which was taken as the template.

The operation to create an instrument child method, currently exposes a twofold concept:

Case 1.) The master method is already tied to an instrument with a specific configuration and thus contains all instrument relevant parameters.

Case 2.) The master method is purely specifying data analysis method parameters and is not tied to any instrument, or in other words was chosen to be an instrument ‘None’ method. This method contained no instrumentation parameters at all.

When creating an instrument child method, which is usually what is done by normal operators, the following instrument matching criteria are used to tell if a copy is allowed or not:

For case 1.) the instrument child method is still in the state released but follows the following constraints:

a) for LC (liquid chromatography) instruments the designated instrument is only allowed for selection when it contains exactly the same modules with exactly the same module options. The idea behind this is that the derived method is instantly usable and fully complies to all settings of the master method. For the user there is no further validation checking necessary.

b) For GC (gas chromatography) instruments all instruments of the same type 6890 are considered identical and all instruments of the type 6850 are considered identical at the method wizard UI scope of view. The compatibility is fully checked to every detail of all options at the time when the run about to be executed. The execution will stop when the options are not compatible (one possibility is that the GC was changed at a later time than when the method was created). When the execution is allowed then there is no validation checking necessary any more from the user's side. When the method does not execute, it should be set to the unreleased state by an operator having the release methods capability, and should even be archived and deleted from the system, since it is unusable.

c) For GIC (gas-liquid chromatography) instruments all instruments with the same basic type of modules are considered identical from the point of view of the method wizard UI. Only at beginning of the execution point in time a detailed check is performed and it will fail if things do not match properly. Then proceed as under b).

For case 2.)

a) when the instrument child method is intended to be as well purely a data analysis method (via instrument None selection) then it will stay in the state released. This is useful when using the method for reprocessing copies of data without interfering at all with the master method for potential peak identification editing.

b) when the data analysis master method is specialized to become runnable on an instrument, then any one instrument is selectable by the user. There are no restrictions imposed, since no instrument settings exist in the master method. However since the instrument parameters all start with initial values, the method's state is dropped to unreleased since an operator must supply correct instrument settings in order to comply to the SOP. Once this is done the method should be set to released state by the user.

Only now the shortcomings of this concept become apparent in laboratory environments where there are many instruments which could potentially execute the chemistry and have the physical capabilities to run the instrument part of the master method. But it is found that the instrument hardware often times slightly varies in their options configuration.

It is now desirable to allow as well the method's usage on such comparable but not 100% identical instruments.

The demand has become clear that instrument child methods should have the possibility to maintain and enforce the strictness, and should be enhanced to a concept where the chemist can decide more freely about which is a compatible instrument according to his/her knowledge. This of course makes him/her responsible to ensure that the required settings of the underlying SOPs are met, concerning all the instrument parameters. The chemist should verify and even validate the method as to which ever his/her company's standards request of him/her.

A benefit of this concept fully arises in conjunction with the concept defined above about a secured usage of a method in its lifecycle states.

Next, a concept description per component will be given.

In the following, a capability in a management console will be explained. A capability may be provided for the Cerity system to be set in the Microsoft management console for Cerity. This capability means: Allow user to freely choose an instrument in the instrument method wizard. This capability is to be set for every applicable role in the Cerity Software.

In the following, the instrument method wizard dialog according to an exemplary embodiment will be explained.

The users holding a role with this capability (allowed to use dissimilar instruments) will then be entitled (upon restart of the UI client) to set an option in the instrument method wizard's instrument page, which allows him/her to choose freely among all the instruments which are setup in the Cerity cluster.

For an LC method this means that for all recognized modules all the parameters are kept (however 3D UV settings are dropped if the target instrument does not have a 3D UV license, then also all 3D DA is dropped) and for newly detected modules the parameters start with initial values. Module parameters for modules which do not exist in the selected instrument are dropped.

For a GC method this means that all GC parameters should be rechecked and possibly be re-entered because they can possibly be all lost. So for GC this option should be used wisely. It should actually only be used when the instrument method is not runnable on the target GC, because this means that the master method's GC options and the target GC options are at least slightly different.

For instruments with GIC modules holds the same as for GC.

When the new option is not checked in the instrument method wizard's instrument page, then the exact copy is created.

Next, a user's obligation will be explained.

When using this option, the user should then check all instrument parameter settings and possibly correct or add all or only some of the instrument parameter settings. This is to ensure that the required settings of an underlying SOP are fully and truly met. Only if the detector module is different the user should also check the setup of the default integration event settings for this new and different detector, as well as setup the identification to the signal, denoted by the signal name, of this new and different detector so that the compounds will be correctly associated. If this is completed the user should set the instrument child method to the state released in order to expose the state that the method fully correct.

In the following, operational specifications, more particularly user interface specifications will be explained.

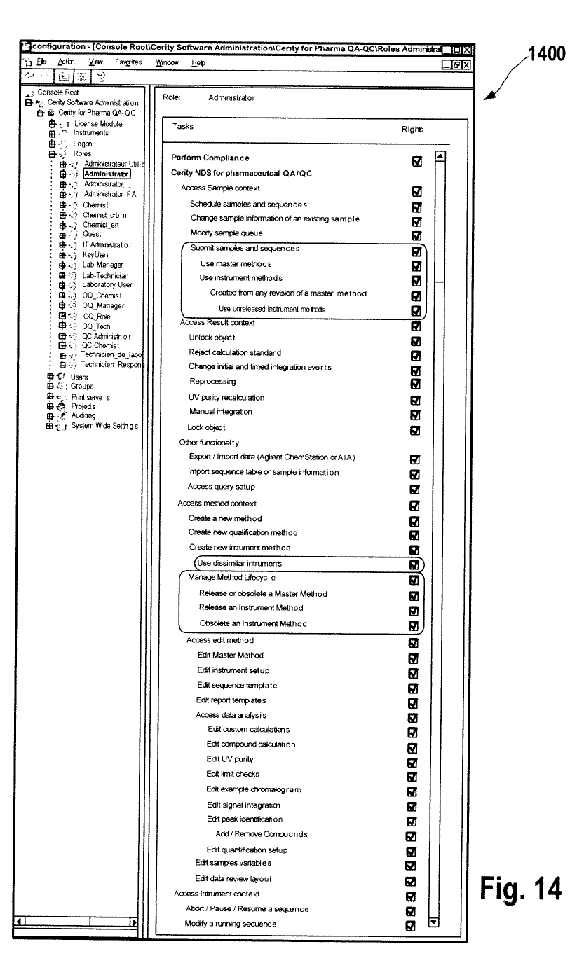

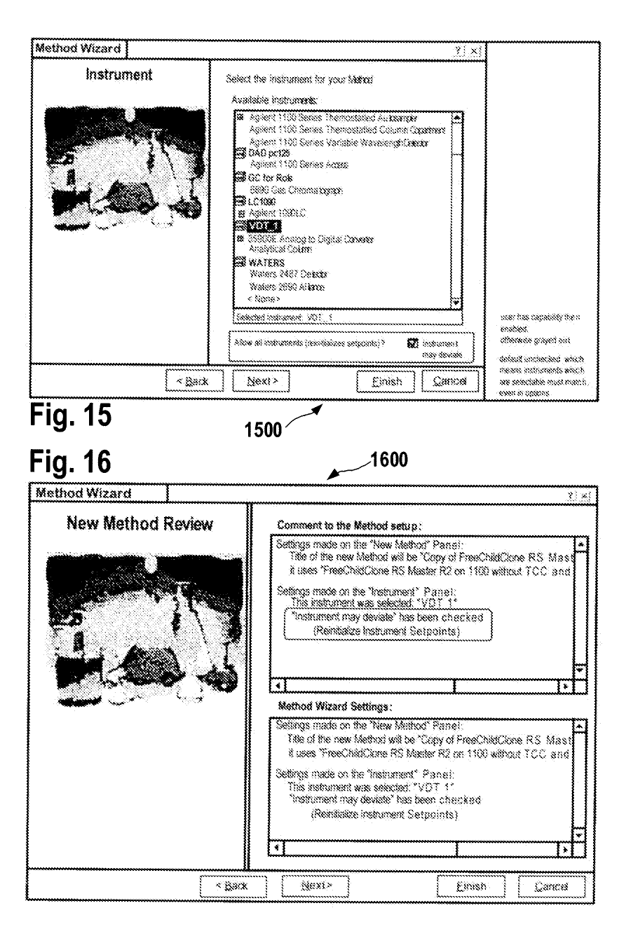

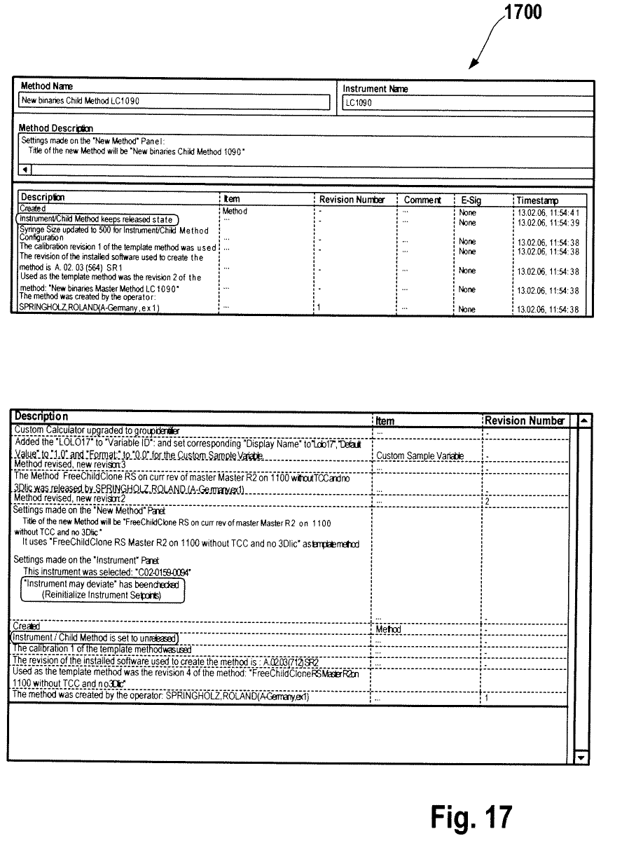

A management console screen 1400 is shown in FIG. 14. A method wizard instrument page screen 1500 is shown in FIG. 15 The instrument nodes will look enabled and can be selected when the checkmark is set. A method wizard summary page screen 1600 (see FIG. 16) will show clearly if this feature was selected. Method logbook entries 1700 are shown in FIG. 17.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

What is claimed is:

1. A device for managing a master method, defined by a first set of required configurations, and a child method, derived from the master method and being defined by a second set of required configurations, wherein each of the master method and the child method comprises a sequence of instructions for an instrument for at least one of analysing, testing, and measuring a substance, wherein each of the first and the second set of required configurations comprises a set of operating conditions being required by the instrument for an execution of the master method and of the child method, respectively, the device comprising
a determining unit adapted for determining if the second set of required configurations differs from the first set of required configurations;
a classification unit adapted for classifying the child method based on a result of the determination.

2. The device of claim 1,
wherein the classification unit is adapted for classifying the child method as an unreleased method if the second set of required configurations differs from the first set of required configurations, wherein an unreleased method is a method which has not yet been approved for unrestricted use by any user.

3. The device of claim 1,
wherein the classification unit is adapted for classifying the child method as a released method if the second set of required configurations is identical to the first set of required configurations, wherein a released method is a method which has already been approved for one of an unrestricted use and a restricted use by a user.

4. The device of claim 1,
wherein the classification unit is adapted for classifying the child method based on at least one predetermined decision criteria selected from the group consisting of an empiric decision criteria, an expert rule, and a Fuzzy logic based decision criteria.

5. The device of claim 1,
comprising a reclassification unit adapted for modifying the classification of the child method upon receipt of a reclassification request of a user, wherein modifying the classification includes one of changing a status of the child method from unreleased to released, changing a status of the child method from released to unreleased, changing a status of the child method from unreleased to released with restrictions, and changing a status of the child method from released with restrictions to unreleased.

6. The device of claim 5,
wherein the reclassification unit is adapted for accepting or rejecting a reclassification request based on a role of a user providing the reclassification request, particularly based on a degree of a technical competence assigned to a user or based on a position of a user in a hierarchy of a social structure.

7. The device of claim 5,
comprising a flag unit adapted for flagging a reclassified child method with a flag indicative of an identity of the user having provided the reclassification request.

8. The device of claim 1,
wherein each of the master method and the child method comprises a sequence of instructions for operating a measurement apparatus or a life science instrument.

9. The device of claim 1,
wherein the master method is a certified method, particularly is an officially certified method or a company-wide certified method, more particularly is a Food and Drug Administration certified method.

10. The device of claim 1,
wherein the child method is an uncertified method, particularly is a method not being officially certified or not being company-wide certified, more particularly is a method which is not certified by the Food and Drug Administration.

11. The device of claim 1,
wherein the child method is an updated version of the master method, wherein an updated version is a successor version replacing or supplementing a previously used version which has been used earlier in time.

12. The device of claim 1,
comprising an authorization unit adapted for allocating a child method access mode to a user desiring access to the child method, which child method access mode is indicative of an access authorization for the user to the child method.

13. The device of claim 12,
wherein the access authorization includes one of an unlimited permission, a limited permission, and a prohibition for the user to use the child method.

14. The device of claim 12,
wherein the authorization unit is adapted for allocating the child method access mode to the user based on a role of a user desiring access to the child method, particularly based on a degree of a technical competence assigned to a user or based on a position of a user in a hierarchy of a social structure.

15. The device of claim 12,
wherein the authorization unit is adapted for allocating the child method access mode of the group consisting of an unrestricted access to the child method, a restricted access to the child method, and a refused access to the child method.

16. The device of claim 15,
wherein an unrestricted access to the child method includes a permission for the user to get access to the child method without any restrictions.

17. The device of claim 15,
wherein a restricted access to the child method includes a permission for the user to get access to the child method within limits of at least one restriction.

18. The device of claim 15,
wherein a refused access to the child method includes a prohibition for the user to get access to the child method.

19. The device of claim 12,
wherein the authorization unit is adapted for allocating a master method access mode to a user which master method access mode is representative for an access authorization for the user to the master method.

20. The device of claim 19,
wherein the authorization unit is adapted for allocating the master method access mode to the user based on a role of a user desiring access to the master method, particularly based on a degree of a technical competence assigned to a user or based on a position of a user in a hierarchy of a social structure.

21. The device of claim 19,
wherein the authorization unit is adapted for allocating the master method access mode of the group consisting of an unrestricted access to the master method, a restricted access to the master method, and a refused access to the master method.

22. The device of claim 21,
wherein an unrestricted access to the master method includes a permission for the user to get access to the master method without any restrictions.

23. The device of claim 21,
wherein a restricted access to the master method includes a permission for the user to get access to the master method within limits of at least one restriction.

24. The device of claim 21,
wherein a refused access to the master method includes a prohibition for the user to get access to the master method.

25. The device of claim 1,
wherein each of the first set of required configurations and the second set of required configurations is indicative of at least one operating condition of the group consisting of a measurement routine parameter, a manufacture procedure parameter, a life science experiment parameter, a sample analysis procedure parameter, and a measurement device operation parameter.

26. The device of claim 1,
wherein the child method is derived from the master method by at least one of updating, correcting, improving, extending, limiting, concretizing, modifying, and application-specifically adapting the sequence of instructions.

27. The device of claim 1,
wherein each of the master method and the child method defines an operation of at least one of the group consisting of a measurement device for performing a measurement in a coupled measurement environment, a measurement device for measuring at least one physical, chemical or biological parameter, a measurement device for performing a measurement of a fluidic sample, a sensor device, a device for chemical, biological and/or pharmaceutical analysis, a fluid separation system adapted for separating compounds of a fluid, a test device for testing a device under test or a substance, a capillary electrophoresis device, a liquid chromatography device, a gas chromatography device, an electronic measurement device, and a mass spectroscopy device.

28. A method of managing a master method, defined by a first set of required configurations, and a child method, derived from the master method and defined by a second set of required configurations, wherein each of the master method and the child method comprises a sequence of instructions for an instrument for at least one of analysing, testing, and measuring a substance, wherein each of the first and the second set of required configurations comprises a set of operating conditions being required by the instrument for an execution of the master method and of the child method, respectively, using the instrument, the method comprising
determining if the second set of required configurations differs from the first set of required configurations;
classifying the child method based on a result of the determination.

29. A computer-readable medium, in which a computer program of managing a master method, defined by a first set of required configurations, and a child method, derived from the master method and defined by a second set of required configurations, or a program element of managing a master method, defined by a first set of required configurations, and a child method, derived from the master method and defined by a second set of required configurations, is stored, which computer program or program element, when being executed by a processor, is adapted to control or carry out the method of claim 28.
